(19) United States
(12) Patent Application Publication
(10) Pub. No.: US 2005/0238919 A1
(43) Pub. Date: Oct. 27, 2005

(54) Organic electroluminescent device

(75) Inventor: Jun Ogasawara, Kanagawa (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/110,702

(22) Filed: Apr. 21, 2005

(30) Foreign Application Priority Data
Apr. 23, 2004 (JP) 2004-128712

(51) Int. Cl. H05B 33/14

(52) U.S. Cl. 428/690; 428/917; 428/448; 313/504; 313/506

(57) ABSTRACT

An organic electroluminescent device including a pair of electrodes, and at least one organic layer including a luminescent layer between the pair of electrodes, in which the organic electroluminescent device includes at least one compound selected from the group consisting of the compounds represented by Formula (1), (2) and (3):

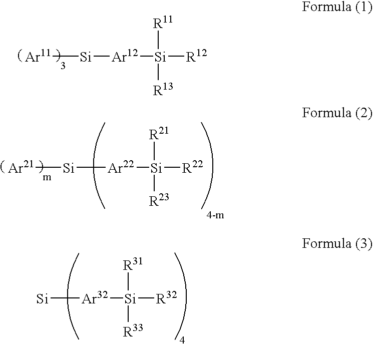

### CROSS-REFERENCE TO RELATED APPLICATION

This application claims priority under 35 USC 119 from Japanese Patent Application No. 2004-128712, the disclosure of which is incorporated by reference herein.

### BACKGROUND OF THE INVENTION

1. Field of the Invention

The present invention relates to an organic electroluminescent device capable of luminescence by converting electric energy to light.

2. Description of the Related Art

There is currently active research and development related to various display devices, and organic electroluminescent devices are receiving attention as display devices with particular promise due to their capability of emission with high luminance at low voltages.

Japanese Patent Application Laid-Open (JP-A) No. 2002-100476 discloses a luminescent device that has at least a luminescent layer containing a luminescent material and a host material, and exhibits luminescence with a maximum wavelength of 500 nm or less, and has a higher value of the lowest excitation triplet energy level of the host material than that of the luminescent material. C-15 noted in paragraph No. 0133 of the above JPA is disclosed as a host material.

Applied Physics Letters, 83, 3818 (2003) discloses UGH1 (diphenyl di(o-tolyl)silane) and UGH2 (p-bis(triphenylsilyl)benzene), compounds containing silicon atoms, as host materials used for a luminescent layer of a blue luminescent device. The paper, however, discloses UGH1 and UGH2 only, and other compounds are not noted.

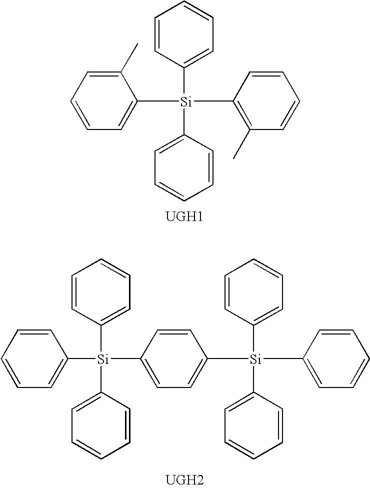

Since UGH1 and UGH2 each are highly crystalline, it is expected that when any of these compounds is used in a device, crystallization in the device would readily be caused—due to the heat-emission accompanying device driving or long-term storage.

It is one of the most important technical objectives regarding organic EL devices today to improve device durability. It has been demanded that driving durability and storage stability be improved.

### SUMMARY OF THE INVENTION

The present invention has been made in consideration of the above-described situations and provides an organic electroluminescent device.

A first aspect of the invention is to provide an organic electroluminescent device comprising a pair of electrodes, and at least one organic layer including a luminescent layer between the pair of electrodes, in which the organic electroluminescent device comprises a compound represented by Formula (1): 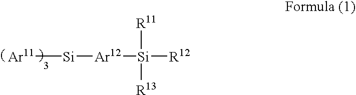
wherein Ar¹¹ may be the same as or different from each other, and represent an aryl group or a heteroaryl group; Ar¹² represents an orthophenylene group, a methaphenylene group, a biphenylene group, a group in which 3 to 6 benzene rings are linked, an arylene group of a condensed ring in which 2 to 6 aromatic rings are condensed, or a heteroarylene group; Ar¹² may be a group in which an arylene group and a heteroarylene group are linked to each other; and R¹¹, R¹², and R¹³ may be the same as or different from each other, and represent an alkyl group, an aryl group, or a heteroaryl group, and
wherein compounds represented by Formula (1) exclude diphenyl di(o-tolyl)silane and (p-bis(triphenylsilyly)benzene.

A second aspect of the invention is to provide an organic electroluminescent device comprising a pair of electrodes and at least one organic layer including a luminescent layer between the pair of electrodes, in which the organic electroluminescent device comprises a compound represented by Formula (2): 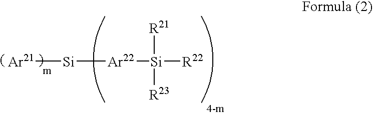
wherein Ar²¹ represents an aryl group or a heteroaryl group, and does not have a silyl group as a substituent therein; m represents 1 or 2, and when m represents 2, Ar²¹ may be the same as or different from each other; Ar²² may be the same as or different from each other, and represents an arylene group or a heteroarylene group; Ar²² may be a group in which an arylene group and a heteroarylene group are linked to each other; R²¹, R²², and R²³ may be the same as or different from each other, and represent an alkyl group, an aryl group, or a heteroaryl group.

A third aspect of the invention is to provide an organic electroluminescent device comprising a pair of electrodes, and at least one organic layer including a luminescent layer between the pair of electrodes, in which the organic electroluminescent device comprises a compound represented by Formula (3): 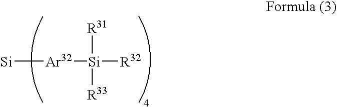
wherein Ar³² may be the same as or different from each other, and represents an arylene group, a group including an azole structure, a group including an azine structure having two or more heteroatoms, a group including a furan structure, or a group including a thiophene structure; Ar³² may be a group in which two or more of an arylene group, a group including an azole structure, a group including an azine structure having two or more heteroatoms, a group including a furan structure, or a group including a thiophene structure are linked to each other; and R³¹, R³², and R³³ may be the same as or different from each other, and represent an alkyl group, an aryl group, or a heteroaryl group.

### DETAILED DESCRIPTION OF THE INVENTION

An organic electroluminescent device (hereinafter, sometimes referred to simply as a “luminescent device”) of the present invention comprises at least one organic layer including a luminescent layer between a pair of electrodes, and comprises at least one compound selected from the group consisting of the compounds represented by Formula (1), (2) and (3). In other words, in the organic electroluminescent device of the invention, a single compound or a plurality of compounds selected from the group consisting of the compounds represented by Formula (1), (2), and (3) are contained in a luminescent layer or at least one organic layer including a luminescent layer.

Formula (1) will be set forth in detail. In Formula (1), Ar¹¹ may be the same as or different from each other, and represent an aryl group or a heteroaryl group. Ar¹² represents an orthophenylene group, a methaphenylene group, a biphenylene group, a group in which 3 to 6 benzene rings are linked, an arylene group of a condensed ring in which 2 to 6 aromatic rings are condensed, or a heteroarylene group. R¹¹, R¹², and R¹³ may be the same as or different from each other, and represent an alkyl group, an aryl group, or a heteroaryl group. Of compounds represented by Formula (1), UGH1 (diphenyl di(o-tolyl)silane) and UGH2 (p-bis(triphenylsilyly)benzene) are excluded.

Ar¹¹ may be the same as or different from each other, and represents an aryl group or a heteroaryl group.

An aryl group represented by Ar¹¹ may be an aryl group of a single ring, or an aryl group of a condensed ring in which two or more rings are condensed, and is preferably an aryl group having 6 to 30 carbon atoms, more preferably 6 to 20 carbon atoms, and still more preferably 6 to 12 carbon atoms. Examples of the aryl groups represented by Ar¹¹ include a phenyl group, a naphtyl group, an anthryl group, a phenanthryl group, a pyrenyl group, a triphenylenyl group, a biphenyl group, and a terphenyl group. Of these, the aryl group represented by Ar¹¹ is preferably a phenyl group, a triphenylenyl group, a biphenyl group, or a terphenyl group, more preferably a phenyl group, a biphenyl group, or a terphenyl group, and still more preferably a phenyl group.

A heteroaryl group represented by Ar¹¹ may be a heteroaryl group of a single ring, or a hetroaryl group of a condensed ring in which two or more rings are condensed, and is preferably an aryl group having 1 to 20 carbon atoms, more preferably 2 to 12 carbon atoms, and still more preferably 2 to 10 carbon atoms. Specific examples of the heteroaryl group represented by Ar¹¹ include a pyridyl group, a quinolyl group, an isoquinolyl group, an acridinyl group, a phenanthridinyl group, a pteridinyl group, a pyradinyl group, a quinoxalinyl group, a pyrimidinyl group, a quinazolyl group, a pyridazinyl group, a cinnolinyl group, a phthalazinyl group, a triazinyl group, an oxazolyl group, a benzooxazolyl group, a thiazolyl group, a benzothiazolyl group, an imidazolyl group, a benzoimidazolyl group, a pyrazolyl group, an indazolyl group, an isooxazolyl group, a benzoisooxazolyl group, an isothiazolyl group, an benzoisothiazolyl group, an oxadiazolyl group, a thiadiazolyl group, a triazolyl group, a tetrazolyl group, a furyl group, a benzofuryl group, a thienyl group, a benzothienyl group, a pyrrolyl group, an indolyl group, an imidazopyridinyl group, and a carbazolyl group. The heteroaryl group represented by Ar¹¹ is preferably a pyridyl group, a pyradinyl group, a pyrimidinyl group, a triazinyl group, an oxazolyl group, a thiazolyl group, an imidazolyl group, a pyrazolyl group, an oxadiazolyl group, a thiadiazolyl group, a triazolyl group, a furyl group, a thienyl group, a pyrrolyl group, an indolyl group, an imidazopyridinyl group, or a carbazolyl group, more preferably a pyridyl group, a triazinyl group, an imidazopyridinyl, or a carbazolyl group, and still more preferably a pyridyl group.

An aryl group or a heteroaryl group represented by Ar¹¹ may have a substituent. The substituent can be selected from Substituent Group A mentioned below. It is preferable that a further silyl group is not placed in Ar¹¹ as a substituent.

Substituent Group A will be described.

Substituent Group A includes alkyl groups (preferably having 1 to 30 carbon atoms, more preferably 1 to 20 carbon atoms, and particularly preferably 1 to 10 carbon atoms, such as methyl, ethyl, iso-propyl, tert-butyl, n-octyl, n-decyl, n-hexadecyl, cyclopropyl, cyclopentyl, and cyclohexyl), alkenyl groups (preferably having 2 to 30 carbon atoms, more preferably 2 to 20 carbon atoms, and particularly preferably 2 to 10 carbon atoms, such as vinyl, allyl, 2-butenyl, and 3-pentenyl), alkynyl groups (preferably having 2 to 30 carbon atoms, more preferably 2 to 20 carbon atoms, and particularly preferably 2 to 10 carbon atoms, such as propargyl and 3-pentynyl), aryl groups (preferably having 6 to 30 carbon atoms, more preferably 6 to 20 carbon atoms, and particularly preferably 6 to 12 carbon atoms, such as phenyl, p-methylphenyl, naphthyl, and anthranyl), amino groups (preferably having 0 to 30 carbon atoms, more preferably 0 to 20 carbon atoms, and particularly preferably 0 to 10 carbon atoms, such as amino, methylamino, dimethylamino, diethylamino, dibenzylamino, diphenylamino, and ditolylamino), alkoxy groups (preferably having 1 to 30 carbon atoms, more preferably 1 to 20 carbon atoms, and particularly preferably 1 to 10 carbon atoms, such as methoxy, ethoxy, buthoxy, and 2-ethylhexyloxy), aryloxy groups (preferably having 6 to 30 carbon atoms, more preferably 6 to 20 carbon atoms, and particularly preferably 6 to 12 carbon atoms, such as phenyloxy, 1-naphthyloxy, and 2-naphthyloxy), heteroaryloxy groups (preferably having 1 to 30 carbon atoms, more preferably 1 to 20 carbon atoms, and particularly preferably 1 to 12 carbon atoms, such as pyridyloxy, pyrazyloxy, pyrimidyloxy and quinolyloxy), acyl groups (preferably having 1 to 30 carbon atoms, more preferably 1 to 20 carbon atoms, and particularly preferably 1 to 12 carbon atoms, such as acetyl, benzoyl, formyl, and pivaloyl), alkoxycarbonyl groups (preferably having 2 to 30 carbon atoms, more preferably 2 to 20 carbon atoms, and particularly preferably 2 to 12 carbon atoms, such as methoxycarbonyl, and ethoxycarbonyl), aryloxycarbonyl groups (preferably having 7 to 30 carbon atoms, more preferably 7 to 20 carbon atoms, and particularly preferably 7 to 12 carbon atoms, such as phenyloxycarbonyl), acyloxy groups (preferably having 2 to 30 carbon atoms, more preferably 2 to 20 carbon atoms, and particularly preferably 2 to 10 carbon atoms, such as acetoxy and benzoyloxy), acylamino groups (preferably having 2 to 30 carbon atoms, more preferably 2 to 20 carbon atoms, and particularly preferably 2 to 10 carbon atoms, such as acetylamino and benzoylamino), alkoxycarbonylamino groups (preferably having 2 to 30 carbon atoms, more preferably 2 to 20 carbon atoms, and particularly preferably 2 to 12 carbon atoms, such as methoxycarbonylamino), aryloxycarbonylamino groups (preferably having 7 to 30 carbon atoms, more preferably 7 to 20 carbon atoms, and particularly preferably 7 to 12 carbon atoms, such as phenyloxycarbonylamino), sulfonylamino groups (preferably having 1 to 30 carbon atoms, more preferably 1 to 20 carbon atoms, and particularly preferably 1 to 12 carbon atoms, such as methanesulfonylamino, and benzenesulfonylamino), sulfamoyl groups (preferably having 0 to 30 carbon atoms, more preferably 0 to 20 carbon atoms, and particularly preferably 0 to 12 carbon atoms, such as sulfamoyl, methylsulfamoyl, dimethylsulfamoyl, and phenylsulfamoyl), carbamoyl groups (preferably having 1 to 30 carbon atoms, more preferably 1 to 20 carbon atoms, and particularly preferably 1 to 12 carbon atoms, such as carbamoyl, methylcarbamoyl, diethylcarbamoyl, and phenylcarbamoyl), alkylthio groups (preferably having 1 to 30 carbon atoms, more preferably 1 to 20 carbon atoms, and particularly preferably 1 to 12 carbon atoms, such as methylthio, and ethylthio), arylthio groups (preferably having 6 to 30 carbon atoms, more preferably 6 to 20 carbon atoms, and particularly preferably 6 to 12 carbon atoms, such as phenylthio), heteroarylthio groups (preferably having 1 to 30 carbon atoms, more preferably 1 to 20 carbon atoms, and particularly preferably 1 to 12 carbon atoms, such as pyridylthio, 2-benzimizolylthio, 2-benzoxazolylthio, and 2-benzthiazolylthio), sulfonyl groups (preferably having 1 to 30 carbon atoms, more preferably 1 to 20 carbon atoms, and particularly preferably 1 to 12 carbon atoms, such as mesyl and tosyl), sulfinyl groups (preferably having 1 to 30 carbon atoms, more preferably 1 to 20 carbon atoms, and particularly preferably 1 to 12 carbon atoms, such as methanesulfinyl, and benzenesulfinyl), ureido groups (preferably having 1 to 30 carbon atoms, more preferably 1 to 20 carbon atoms, and particularly preferably 1 to 12 carbon atoms, such as ureido, methylureido, and phenylureido), phosphate amide groups (preferably having 1 to 30 carbon atoms, more preferably 1 to 20 carbon atoms, and particularly preferably 1 to 12 carbon atoms, such as diethylphosphate amide, and phenylphosphate amide), a hydroxyl group, a mercapto group, halogen atoms (e.g., fluorine atom, chlorine atom, bromine atom, iodine atom), a cyano group, a sulfo group, a carboxyl group, a nitro group, hydroxamic acid groups, a sulfino group, hydrazine groups, imino groups, heterocycle groups (preferably having 1 to 30 carbon atoms, more preferably 1 to 12 carbon atoms, and examples of the heteroatoms include a nitrogen atom, an oxygen atom, and a sulfur atom, and specific examples of the group include imidazoyl, pyridyl, quinolyl, furyl, thienyl, piperidinyl, morphorino, benzoxazolyl, benzimidazolyl, benzthiazoyl, a carbazoyl group, and a azepinyl group), and silyl groups (preferably having 3 to 40 carbon atoms, more preferably 3 to 30 carbon atoms, and particularly preferably 3 to 24 carbon atoms, such as trimethylsilyl, and triphenylsilyl).

The substituent an aryl group or a heteroaryl group represented by Ar¹¹ may have is preferably an alkyl group (preferably having 1 to 30 carbon atoms, more preferably 1 to 20 carbon atoms, and most preferably 1 to 10 carbon atoms), an aryl group, or a heteroaryl group, more preferably an aryl group, or a heteroaryl group, still more preferably a phenyl group, a biphenyl group, a terphenyl group, or a pyridyl group, and most preferably a phenyl group or a pyridyl group.

Ar¹² represents an orthophenylene group, a methaphenylene group, a biphenylene group, a group in which 3 to 6 benzene rings are linked, an arylene group of a condensed ring in which 2 to 6 aromatic rings are condensed, or a heteroarylene group.

Ar¹², when an arylene group of a condensed ring in which 2 to 6 aromatic rings are condensed, is preferably an arylene group having 6 to 30 carbon atoms, more preferably 6 to 20 carbon atoms, and particularly preferably 6 to 12 carbon atoms. Examples thereof include a naphthylene group, an anthrylene group, a phenanthrenylene group, a pyrenylene group, a perylenylene group, a fluorenylene group, a rubrenylene group, a chrysenylene group, a triphenylenylene group, benzoanthrylene group, a benzophenanthrenylene group, and diphenylanthrylene group.

A heteroarylene group represented by Ar¹² may be a heteroarylene group of a single ring or a heteroarylene group of a condensed ring in which 2 to 6 rings are condensed, and is preferably an heteroarylene group having 1 to 20 carbon atoms, more preferably 2 to 12 carbon atoms, and still more preferably 2 to 10 carbon atoms. Examples thereof include a pyridylene group, a quinolylene group, an isoquinolylene group, an acridinylene group, a phenanthlidinylene group, a pyradinylene group, a quinoxalinylene group, a pyrimidinylene group, a triazilene group, an imidazolylene group, a pyrazolylene group, an oxadiazolylene group, a triazolylene group, a furylene group, a thienylene group, a pyrrolylene group, an indolylene group, and a carbazolylene group.

Ar¹² may be a group in which an arylene group and a heteroarylene group are linked to each other.

Ar¹² is preferably an orthophenylene group, methaphenylene group, a biphenylene group, terphenylene group, a naphthylene group, an anthrylene group, a pyridylene group, a pyrimidylene group, a triazilene group, an oxadiazolylene group, a triazolylene group, a thienylene group, a pyrrolylene group, an indolylene group, or a carbazolylene group, more preferably an orthophenylene group, a methaphenylene group, a biphenylene group, terphenylene group, a naphthylene group, a pyridylene group, a triazilene group, an oxadiazolylene group, a thienylene group, or a carbazolylene group, still more preferably a methaphenylene group, a biphenylene group, a pyridylene group, or an oxadiazolylene group, and most preferably a methaphenylene group, or a biphenylene group.

An arylene group or a heteroarylene group represented by Ar¹² may have a substituent, and the substituent can be selected from the above-described substituent Group A, including an alkyl group. The substituent an aryl group or a heteroaryl group represented by Ar¹² may have is preferably an alkyl group (preferably having 1 to 30 carbon atoms, more preferably 1 to 20 carbon atoms, and particularly preferably 1 to 10 carbon atoms), an aryl group, or a heteroaryl group, more preferably an aryl group, or a heteroaryl group, still more preferably a phenyl group, a biphenyl group, a terphenyl group, or a pyridyl group, and most preferably a phenyl group or a pyridyl group.

R¹¹, R¹², and R¹³ may be the same as or different from each other, and represent an alkyl group, an aryl group or a heteroaryl group.

Alkyl groups represented by R¹¹, R¹², and R¹³ preferably have 1 to 12 carbon atoms, more preferably 1 to 8 carbon atoms, and particularly preferably 1 to 4 carbon atoms. R¹¹, R¹², and R¹³ each are preferably a methyl group, an ethyl group, a propyl group, an n-butyl group, or a t-butyl group, more preferably a methyl group, an ethyl group, or a t-butyl group, and still more preferably a methyl group.

Examples of aryl groups represented by R¹¹, R¹², and R¹³ include the examples noted in the above-described AR¹¹, and their preferable ranges are the same as those in Ar¹¹.

Examples of heteroaryl groups represented by R¹¹, R¹², and R¹³ include the examples noted in the above-described Ar¹¹, and their preferable ranges are the same as those in Ar¹¹.

R¹¹, R¹², and R¹³ each are most preferably a phenyl group.

Alkyl, aryl and heteroaryl groups represented by R¹¹, R², and R¹³ each may have a substituent, and the substituent can be selected from the above-described Group A, but a further silyl group is not placed in R¹¹, R², or R¹³ as a substituent.

Next, Formula (2) will be described. In Formula (2), Ar²′ may be the same as or different from each other, and represents an aryl group or a heteroaryl group.

An aryl or heteroaryl group represented by Ar²¹ have the same meaning as the aryl or heteroaryl group described in the above-described Ar¹¹ and the preferable ranges are the same as those in Ar¹¹.

An aryl group or a heteroaryl group represented by Ar²¹ may have a substituent, and the substituent can be selected from the above-described substituent Group A. A further silyl group is not placed in Ar²¹ as a substituent. The substituent an aryl group or a heteroaryl group represented by Ar²¹ may have is preferably an alkyl group, aryl group, or a heteroaryl group, more preferably an aryl group or a heteroaryl group, still more preferably a phenyl group, a biphenyl group, a terphenyl group, or a pyridyl group, and most preferably a phenyl group or a pyridyl group.

Ar²² may be the same as or different from each other, and represents an arylene group or a heteroarylene group.

An arylene group represented by Ar²² is an arylene group of a single ring or an arylene group of a condensed ring in which 2 or more rings are condensed, and is preferably an arylene group having 6 to 30 carbon atoms, more preferably 6 to 20 carbon atoms, and particularly preferably 6 to 12 carbon atoms. Specific examples of the arylene group represented by Ar²² include a phenylene group, a biphenylene group, a terphenylene group, a naphthylene group, an anthrylene group, a phenanthrenylene group, a pyrenylene group, a perylenylene group, a fluorenylene group, a rubrenylene group, a chrysenylene group, a triphenylenylene group, a benzoanthrylene group, a benzophenanthrenylene group, and diphenylanthrylene group.

A heteroarylene group represented by Ar² is a heteroarylene group of a single ring or a heteroarylene group of a condensed ring in which 2 or more rings are condensed, and is preferably a heteroarylene group having 1 to 20 carbon atoms, more preferably 2 to 12 carbon atoms, and still more preferably 2 to 10 carbon atoms. Specific examples of the heteroarylene group represented by Ar²² include the examples noted in the examples of heteroarylene groups in the above-described Ar²².

Ar²² may be a group in which an arylene group and a heteroarylene group are linked to each other.

Ar²² is preferably a phenylene group, a biphenylene group, terphenylene group, a naphthylene group, an anthrylene group, a pyridylene group, a pyrimidylene group, a triazilene group, an oxadiazolylene group, a triazolylene group, a thienylene group, a pyrrolylene group, an indolylene group, or a carbazolylene group, more preferably a phenylene group, a biphenylene group, terphenylene group, a naphthylene group, a pyridylene group, a triazilene group, an oxadiazolylene group, a thienylene group, or a carbazolylene group, still more preferably a phenylene group, a biphenylene group, or a pyridylene group, and most preferably a paraphenylene group.

An arylene group or a heteroarylene group represented by Ar²² may have a substituent, and specific examples and preferable examples of the substituents Ar²² may have are the same as those of the substituents Ar¹² may have.

R²¹, R²², and R²³ may be the same as or different from each other, and represent an alkyl group, an aryl group or a heteroaryl group.

An alkyl group, an aryl group and a heteroaryl group represented by R²¹, R²², and R²³ are the same in specific examples and preferable ranges as the cases in an alkyl group, an aryl group and a heteroaryl group represented by the above-described R¹¹, R¹², and R¹³.

m represents 1 or 2, and 2 is more preferable.

Next, Formula (3) will be described. In Formula (3), Ar³² may be the same as or different from each other, and represents an arylene group, a group including an azole structure, a group including an azine structure having two or more heteroatoms, a group including a furan structure, or a group including a thiophene structure. R³¹, R³², and R³³ may be the same as or different from each other, and represent an alkyl group, an aryl group or a heteroaryl group.

Ar³² may be the same or different from each other, and represents an arylene group, a group including an azole structure, a group including an azine structure having two or more heteroatoms, a group including a furan structure, or a group including a thiophene structure.

An arylene group represented by Ar² has the same meaning as the arylene group presented by Ar ² and the examples are also the same.

Examples of the group including an azole structure represented by Ar³² include an oxazolylene group, a thiazolylene group, an imizdazolylene group, a pyrazolylene group, an oxadiazolylene group, a thiadiazolylene group, a triazolylene group, an pyrrolylene group, an indolylene group, an imidazopyridinyl group, and a carbazolylene group.

Examples of a group including an azine structure having two or more heteroatoms represented by Ar³² include a pyradylene group, a pyrimidylene group, and a triazilene group.

Examples of a group including a furan structure represented by Ar³² include a group including a benzofuran structure, and a group including a dibenzofuran structure.

Examples of a group including a thiophene structure represented by Ar³² include a group including a benzothiophene structure, a group including a dibenzothiophene structure and a group including a biothiophene structure.

Ar³² may be a group in which two or more of the arylene group, the group including an azole structure, the group including an azine structure having two or more heteroatoms, the group including a furan structure, and the group including a thiophene structure are linked to each other.

Ar³² is preferably a phenylene group, a biphenylene group, terphenylene group, a naphthylene group, an anthrylene group, a pyrimidylene group, a triazilene group, an oxadiazorylene group, a triazorylene group, a pyrrolylene group, an indolylene group, or a carbazolylene group, more preferably a phenylene group, a biphenylene group, terphenylene group, a naphthylene group, a triazilene group, an oxadiazolylene group, or a carbazolylene group, still more preferably a phenylene group, or a biphenylene group, and most preferably a paraphenylene group.

A group represented by Ar³² may have a substituent, and examples and preferable examples of the substituent Ar³² may have are the same as those of the substituents Ar¹² may have.

R³¹, R³², and R³³ may be the same as or different from each other, and represent an alkyl group, an aryl group or a heteroaryl group.

Examples and preferable ranges of an alkyl group, an aryl group and a heteroaryl group represented by R³¹, R³², and R³³ are the same as the cases in an alkyl group, an aryl group and a heteroaryl group represented by the above-described R³¹, R³², and R³³.

Compounds represented by Formula (1), (2) or (3) may be low-molecular weight compounds, or oligomers, or polymers (where the weight-average molecular weight—in terms of polystyrene conversion—is preferably from 1000 to 5000000, more preferably from 2000 to 1000000, and still more preferably from 3000 to 100000). When the compound represented by Formula (1), (2) or (3) is a polymer, the structures represented by Formula (1), (2) or (3) may be included in the polymer main chain, or in the polymer side chain(s). When the compounds is a polymer, the compound may be a homopolymer, or a copolymer. The compound of the invention is preferably a low-molecular weight compound.

Examples of the compounds of Formula (1), (2) or (3) will be illustrated, but the invention is by no means limited thereto.

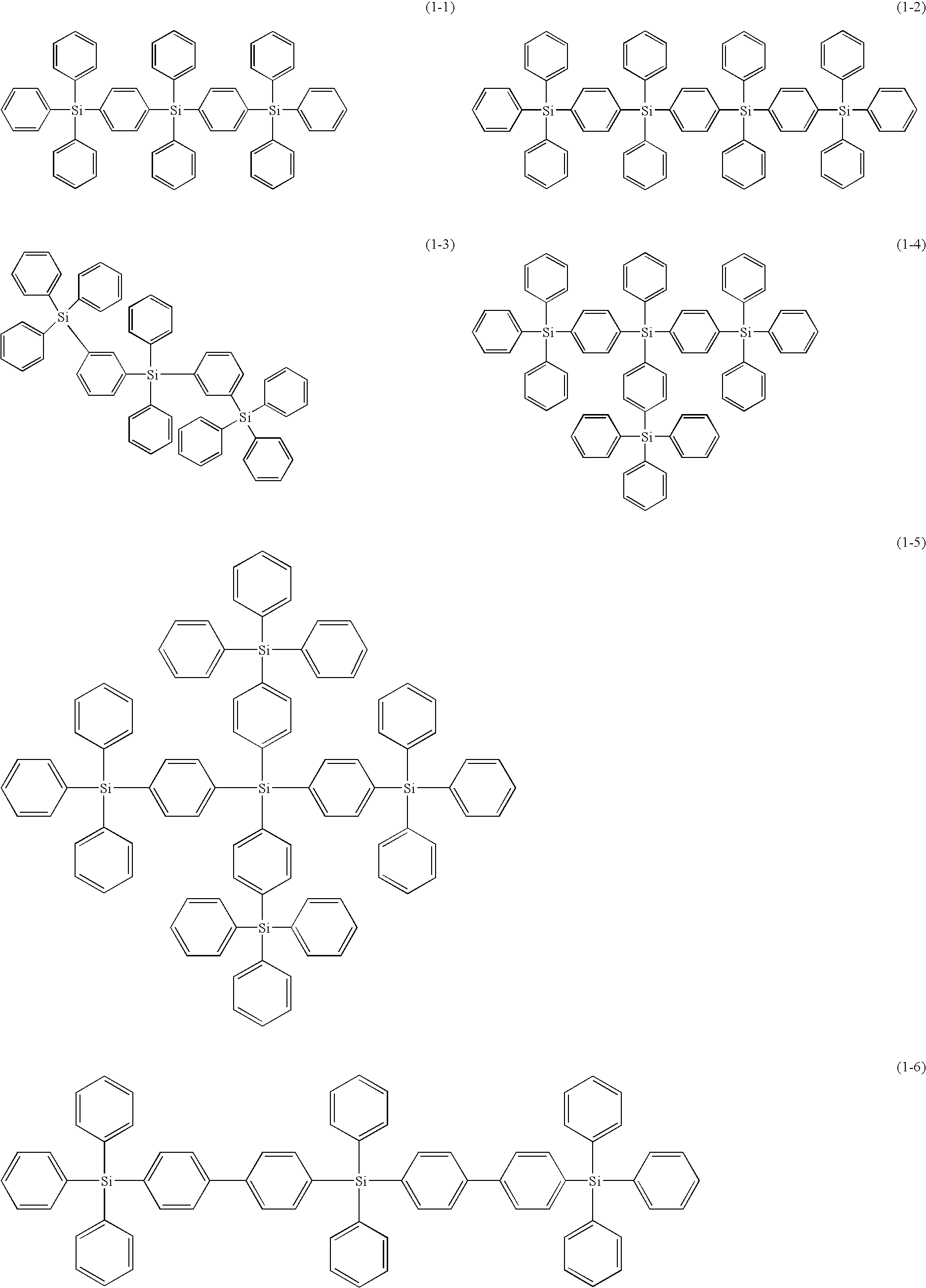

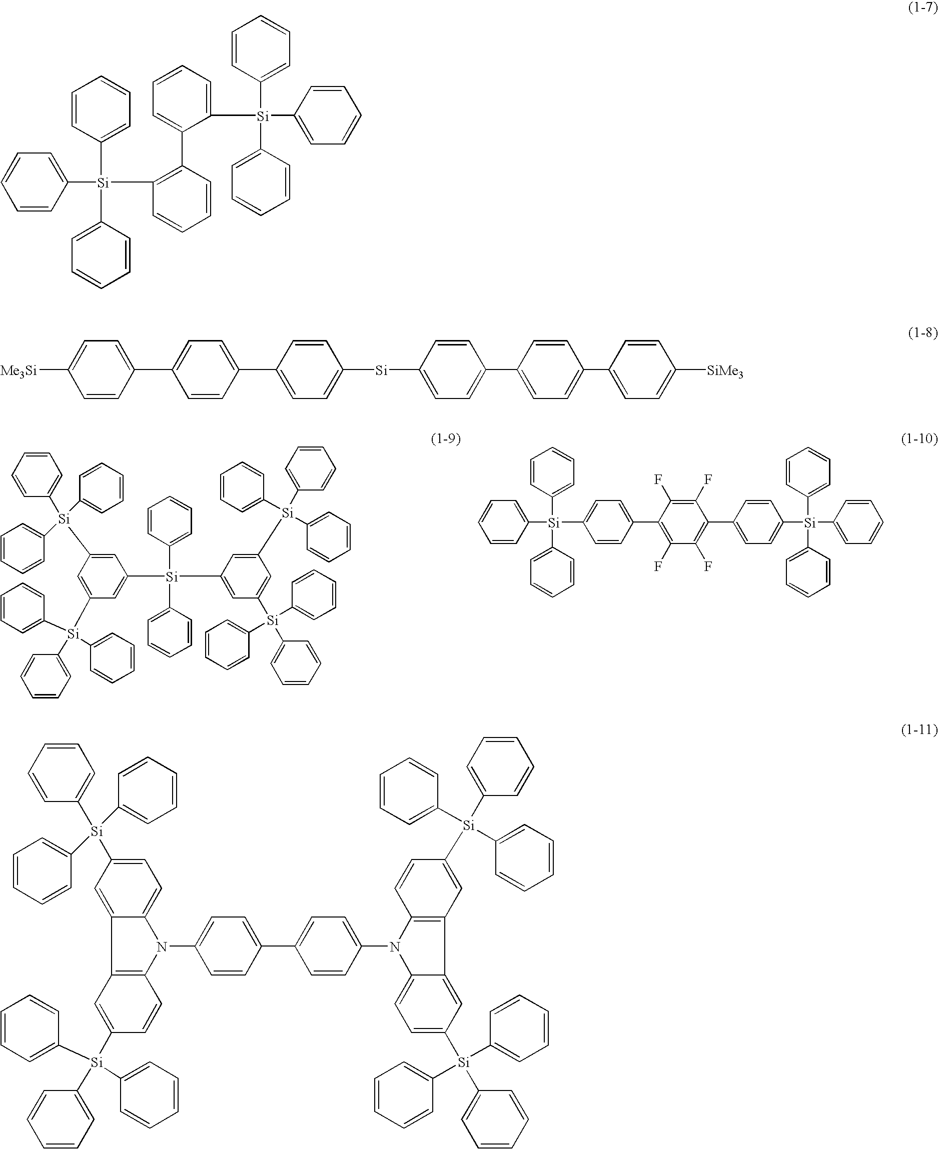

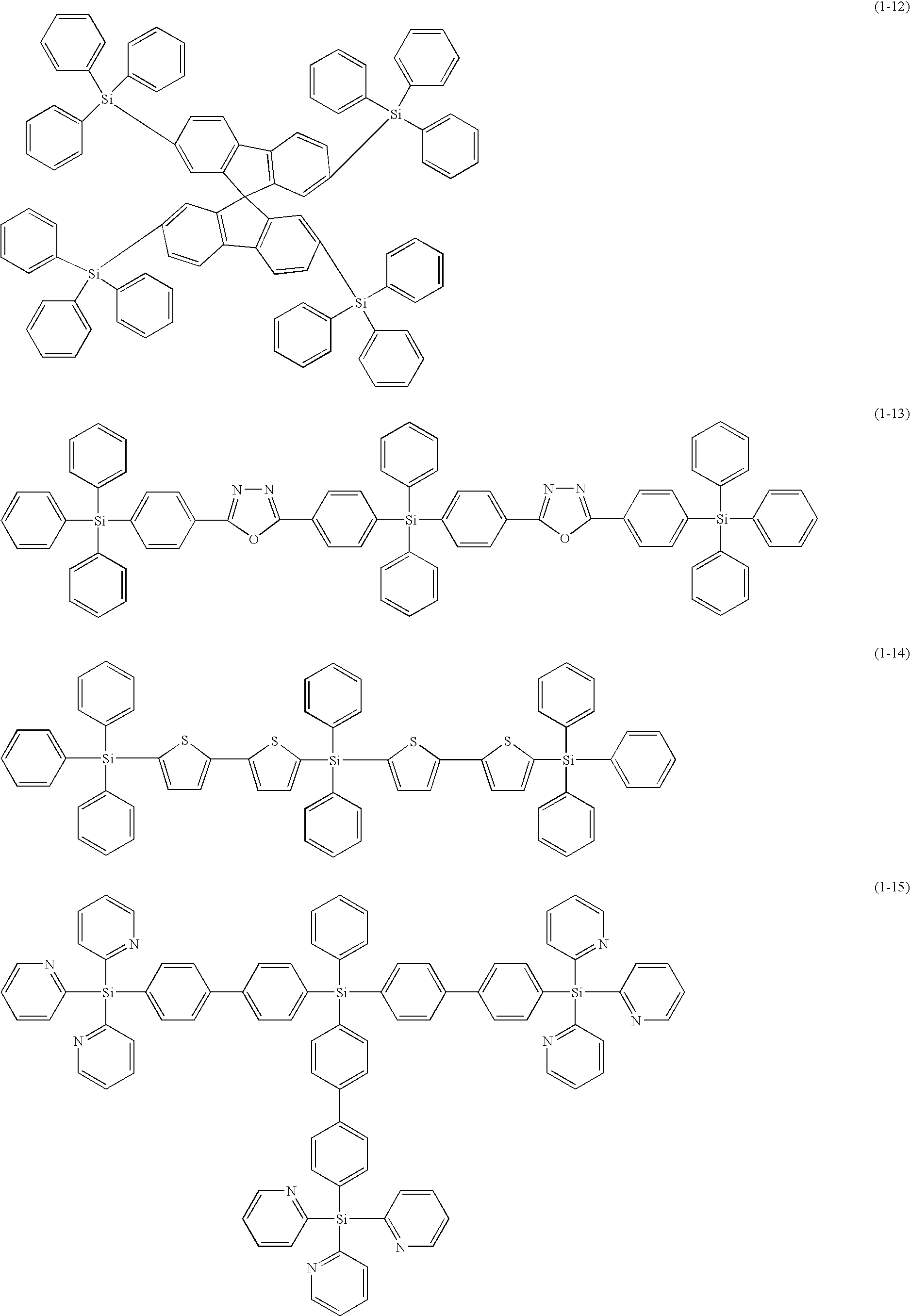

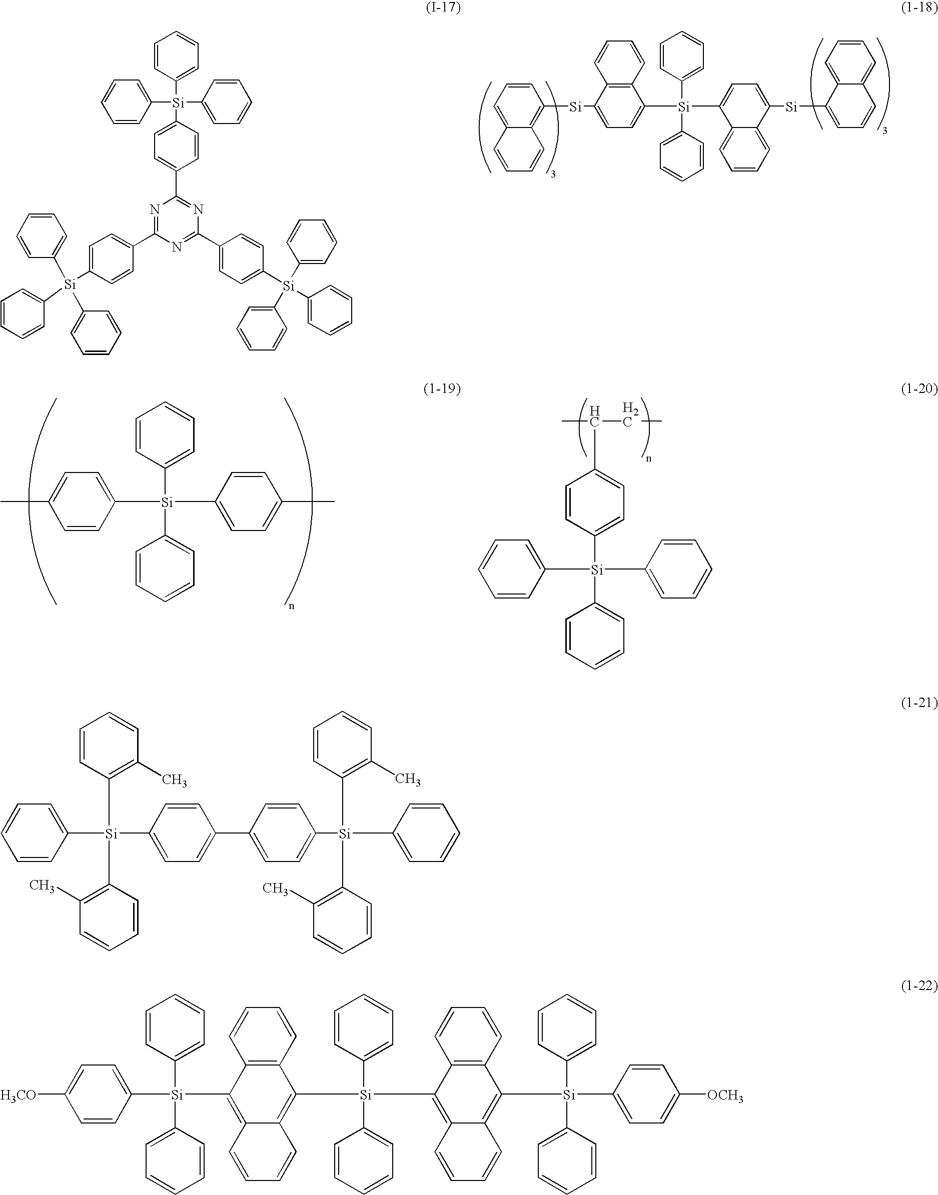

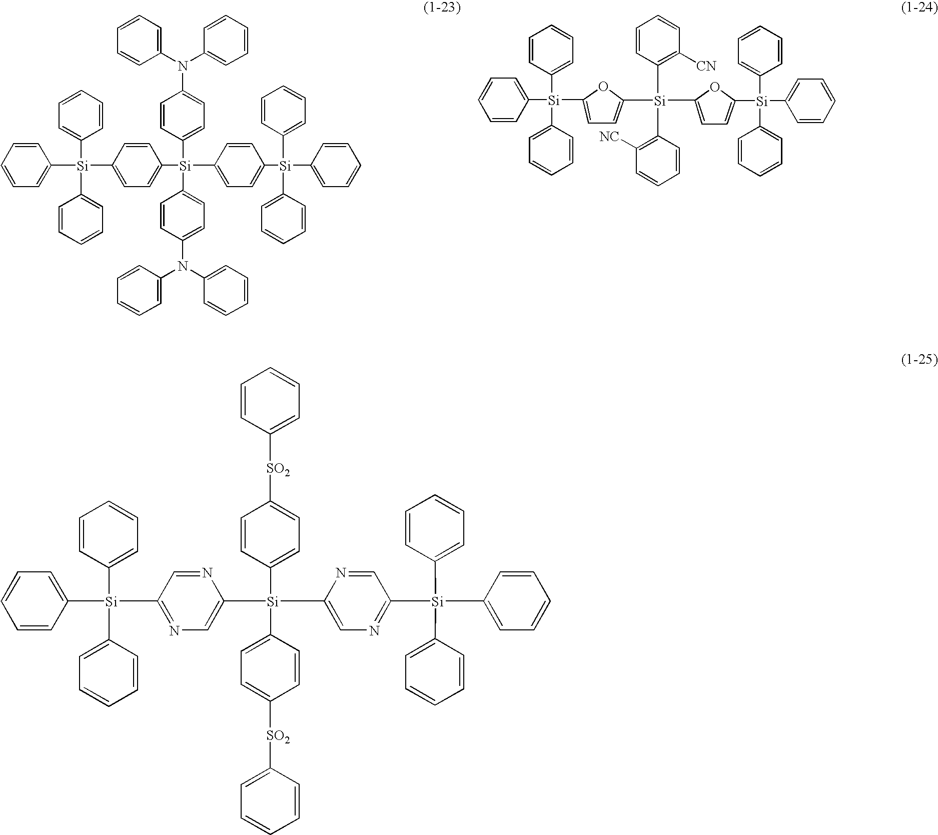

A luminescent device of the invention will be set forth. A luminescent device of the invention preferably makes use of phosphorescence. The phosphorescent materials are not particularly limited, and transition metal complexes are preferable. The central metals of transition metal complexes are not particularly limited, and iridium, platinum, rhenium and ruthenium are preferable, iridium and platinum are more preferable, and iridium is still more preferable.

Hence, a luminescent device of the invention preferably contains at least one compound represented by Formula (1), (2) or (3) and at least one luminescent material in a luminescent layer. Also, the luminescent material is preferably a phosphorescent material.

The transition metal complexes are preferably orthometalated complexes. The term “orthometalated complexes” is the generic name of a compound group described in, for example, Akio Yamamoto “Organometallic Chemistry, Fundamentals and Applications” p. 150, 232, (1982) published by Shokabo Publishing Co., Ltd., and H. Yersin “Photochemistry and Photophysics of Coordination Compounds” pp. 71-77, pp. 135-146, published by Springer-Verlag (1987), the disclosures of which are incorporated by reference herein.

In a phosphorescent material used in the invention, the quantum yield of phosphorescence at 20° C. is preferably 70% or more, more preferably 80% or more, and still more preferably 85% or more.

A luminescent device of the invention preferably utilizes a layer containing a compound having an ionization potential of 5.9 eV or more (more preferably 6.0 eV or more) between the negative electrode and the luminescent layer, and more preferably uses an electron transport layer having an ionization potential of 5.9 eV or more.

For a luminescent device of the invention, the half width of the luminescent spectrum is preferably 100 nm or less, more preferably 90 nm or less, still more preferably 80 nm or less, and particularly preferably 70 nm or less from the viewpoint of color purity.

In addition, a luminescent device of the invention includes the case where the excitation energy of the phosphorescent material causes another luminescent material to be excited, and the substantial light emission is by this other material.

A luminescent device of the invention may have a hole injecting and transporting compound and/or an electron injecting and transporting compound in the luminescent layer thereof. Particularly, in a luminescent device of the invention, the luminescent layer preferably contains a compound represented by Formula (1), (2) or (3). In this case, it is preferable that the luminescent layer further contains a hole injecting and transporting compound and/or electron injecting and transporting compound.

A hole injecting and transporting compound contained in a luminescent layer means a compound having the function of injection and transport of holes in the luminescent layer. Addition of this compound to the luminescent layer promotes the injection or transport of a hole, or causes the ionization potential (IP) value to be suitable for hole injection and transport (for example values given below).

The inclusion of a hole injecting and transporting compound in the luminescent layer makes easy the injection of holes into the luminescent layer, enabling a decrease in the driving voltage, thereby suppressing the decomposition of materials caused by application of high electric fields. Also, since the hole injecting and transporting compound has the function of hole transporting, the decomposition of materials caused by injecting holes into the compounds represented by Formula (1), (2) or (3) can be suppressed.

The IP value of a hole injecting and transporting compound is preferably 5.0 eV to 6.1 eV, more preferably 5.1 eV to 6.0 eV, and still more preferably 5.2 eV to 5.9 eV.

When the luminescent layer contains a compound represented Formula (1), (2) or (3) and a hole injecting and transporting compound, the mass ratio of these compounds in the luminescent layer (the mass of the compound represented by Formula (1) to (3)/the mass of a hole injecting and transporting compound) is preferably 90/10 to 10/90, more preferably 80/20 to 20/80, and still more preferably 70/30 to 30/70. The concentration of a luminescent material contained in the luminescent layer in this case is preferably 0.01 mass % to 60 mass %, more preferably 0.5 mass % to 40 mass %, still more preferably 1 mass % to 20 mass %, and most preferably 2 mass % to 15 mass %.

The hole injecting and transporting compound is preferably a triarylamine derivative, a hydrocarbon-based aromatic derivative (e.g., a benzene derivative, an anthracene derivative, a pyrene derivative), a pyrrole derivative (e.g., a pyrrole derivative, an indole derivative, a carbazole derivatives, and an azepine derivative (e.g., a benzazepine derivative), and more preferably a pyrrole derivative.

An electron injecting and transporting compound contained in a luminescent layer means a compound that has the function of injecting and transporting an electron in the luminescent layer. Addition of this compound to the luminescent layer promotes the injection or transport of a hole, or causes the electron affinity (EA) value to be suitable for hole injection and transport (for example values given below).

The inclusion of an electron injecting and transporting compound in the luminescent layer makes easy the injection of an electron into the luminescent layer, enabling a decrease in the driving voltage, thereby suppressing the decomposition of materials caused by application of high electric fields. Also, since the electron injecting and transporting compound has the function of electron transporting, the decomposition of materials caused by injecting electrons into the compounds represented by Formulas (1), (2) or (3) can be suppressed.

The Ea value of an electron injecting and transporting compound is preferably 2.0 eV to 3.5 eV, more preferably 2.3 eV to 3.4 eV, and still more preferably 2.5 eV to 3.3 eV.

When the luminescent layer contains a compounds represented by Formula (1) to (3) and an electron injecting and transporting compound, the mass ratio of these compounds in the luminescent layer (the mass of the compound represented by Formula (1) to (3)/the mass of an electron injecting and transporting compound) is preferably 90/10 to 10/90, more preferably 80/20 to 20/80, and still more preferably 70/30 to 30/70. The concentration of a luminescent material contained in the luminescent layer in this case is preferably 0.01 mass % to 60 mass %, more preferably 0.5 mass % to 40 mass %, still more preferably 1 mass % to 20 mass %, and most preferably 2 mass % to 15 mass %.

The electron injecting and transporting compound is preferably a metal complex (e.g., an aluminum complex, a zinc complex; however complexes that have as a ligands, a 8-hydroxyquinolinol derivative (e.g., 2-methyl-8-hydroxyquinolinol) are not preferable), a nitrogen-containing heterocyclic compound (e.g., an azole derivative, a pyridine derivative, a triazine derivative), or an organic silicon compound (e.g., a sirole derivative), more preferably a heterocyclic compound containing at least two nitrogen atoms or a metal complex, and still more preferably a heterocyclic compound containing at least two nitrogen atoms. Particularly preferably, the electron injecting and transporting compound is a compounds represented by the following Formula (4). The compounds that may be suitably used also include the compounds represented by Formulas (A-III), (A-IV), (A-V), (A), (A-a), (A-b), (A-c), (B-II), (B-III), (B-IV), (B-V), (B-VI), (B-VII), (B-VIII), and (B-IX) described in JP-A No. 2002-100476, and compounds represented by Formulas (1) to (4) described in JP-A No. 2000-302754 (preferable ranges are described in JP-A Nos. 2002-100476 and 2000-302754, the disclosures of which are incorporated by reference herein).

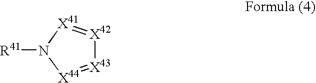

Formula (4) will be described. R⁴¹ represents a hydrogen atom or a substituent. Examples of the substituent represented by R⁴¹ include the substituents listed in Substituent Group A. R⁴¹ is preferably an alkyl group, an aryl group, or a heteroaryl group, more preferably an aryl group or a heteroaryl group, and still more preferably an aryl group.

X⁴¹, X⁴², X⁴³, and X⁴⁴ each independently represent a nitrogen atom, or a substituted or unsubstituted carbon atom. At least one of X⁴¹, X⁴², X⁴³ and X⁴⁴ is a nitrogen atom. Examples of the substituent on a carbon atom include the groups described in R⁴¹, and is preferably an alkyl group, an aryl group, or a heteroaryl group.

It is preferable that X⁴′ is a substituted or unsubstituted carbon atom, X⁴² is a nitrogen atom, and X⁴³ and X⁴⁴ each are substituted carbon atoms. It is also preferable that the substituents on X⁴³ and X⁴⁴ are bonded to form an aromatic ring.

The compound represented by Formula (4) is preferably a compound represented by Formula (5) or (6), and more preferably a compound represented by Formula (6).

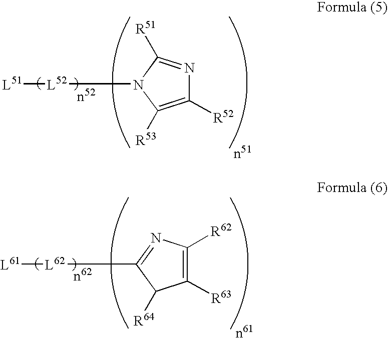

Formula (5) will be set forth. R⁵¹, R⁵² and R⁵³ each independently represent a hydrogen atom or a substituent. Examples of the substituent include the groups described in R⁴¹.

R⁵¹ is preferably an alkyl group, an aryl group, or a heteroaryl group, more preferably an alkyl group, or an aryl group, and still more preferably an alkyl group.

R⁵² and R⁵³ each are preferably an alkyl group, an aryl group, a heteroaryl group, or a group which is capable of combining with one selected from other substituents to form an aromatic ring, more preferably a group which is capable of combining with one selected from other substituents to form an aromatic ring.

L⁵¹ represents a linking group. The linking group may be a polymer main chain such as a polyalkylene or a polyester (for example, the group may form a polyvinylimidazole derivative). L⁵¹ is preferably an aryl linking group, a heteroaryl linking group, an alkyl linking group, or an alkylene polymer main chain, more preferably an aryl linking group, or a heteroaryl linking group, and still more preferably a nitrogen-containing heteroaryl linking group.

n⁵¹ represents an integer of two or larger. A plurality of nitrogen-containing heterocycle groups may be the same or different. When L⁵¹ is not a polymer main chain, n⁵¹ is preferably 2, 3, 4, 5 or 6, and more preferably 3 or 4. When L⁵¹ is a polymer main chain, n⁵² is a value corresponding to a repeat unit of a polymer main chain (for example, for 100 mers of polyvinylimidazole, n⁵² is 100).

L⁵² is a divalent linking group. L⁵² is preferably an alkylene group, an arylene group, a heteroarylene group, an oxygen linking group, a carbonyl linking group, or an amino linking group, and more preferably an alkylene group or an arylene group.

n⁵² represents an integer of zero or larger. When n⁵² is a plural number, a plurality of nitrogen-containing heterocycle groups may be the same or different. When L⁵¹ is not a polymer main chain, n⁵² is preferably 0, 1, 2, or 3, and more preferably 0 or 1. When L⁵¹ is a polymer main chain, n⁵² is a value corresponding to a repeat unit of a polymer main chain (for example, for 100 mers of polyvinylimidazole, n⁵² is 100).

Formula (6) will be described. R⁶² and R⁶³ each independently represent a hydrogen atom or a substituent. Examples of the substituent include the groups described in R⁴′.

R⁶² and R⁶³ each are preferably an alkyl group, an aryl group, a heteroaryl group or a group which is capable of combining with one selected from other substituents to form an aromatic ring, more preferably a group which is capable of combining with one selected from other substituents to form an aromatic ring, and still more preferably a group which is capable of combining with one selected from other substituents to form a nitrogen-containing aromatic ring.

R⁶⁴ represents a hydrogen atom or a substituent. Examples of the substituent include the groups described in R⁴¹. R⁶⁴ is preferably an alkyl group, an aryl group, or a heteroaryl group, more preferably an aryl group or a heteroaryl group, and still more preferably an aryl group.

L⁶¹ represents a linking group. The linking group may be a polymer main chain such as a polyalkylene or a polyester (for example, the group may form a polyvinylimidazole derivative). L⁶¹ is preferably an aryl linking group, a heteroaryl linking group, an alkyl linking group, or an alkylene polymer main chain, more preferably an aryl linking group, or a heteroaryl linking group, and still more preferably an aryl linking group.

L⁶², n⁶¹ and n⁶² respectively have the same meanings as the above-described L⁵², n⁵¹ and n⁵², and the preferable ranges are the same.

The luminescent device of the invention will be explained. The system and the driving method for, and the usage of, the luminescent device are not particularly limited as long as the device contains the compound of the invention. A typical example of the luminescent device is an organic electroluminescent (EL) device.

The method for producing an organic layer of the luminescent device of the invention containing the above-described materials is not limited. Examples thereof include a resistance heating deposition method, an electron beam method, sputtering, a molecule-laminating method, a coating method, an ink-jet method, a printing method, and a transferring method. The production method is preferably a resistance heating deposition method, a coating method or a transferring method from the viewpoints of characteristics and production.

The luminescent device of the invention includes, between a pair of positive and negative electrodes, a single luminescent layer on its own or two or more organic layers including a luminescent layer. The luminescent device may include a hole injecting layer, a hole transport layer, an electron injecting layer, an electron transport layer, and a protective layer, as well as the luminescent layer. Each of these layers may also have other functions. Various materials can be used to form each of these layers.

Specific examples of layer constructions of a luminescent device of the invention include but are not limited to positive electrode/hole transport layer/luminescent layer/electron transport layer/negative electrode, positive electrode/hole transport layer/luminescent layer/electron transport layer/electron injecting layer/negative electrode, positive electrode/hole injecting layer/hole transport layer/luminescent layer/electron transport layer/negative electrode, and positive electrode/hole injecting layer/hole transport layer/luminescent layer/electron transport layer/electron injecting layer/negative electrode.

In addition, for easy injection of a charge into a luminescent layer, a hole injecting promoting layer can further be provided between a luminescent layer and a hole transport layer, or an electron injecting promoting layer can further be provided between a luminescent layer and an electron transport layer.

The IP value of a material contained in a hole injecting promoting layer that can be provide between a luminescent layer and a hole transport layer is preferably not less than the IP value of a material contained in the hole transport layer, and not more than the IP value of a material contained in the luminescent layer, and more preferably close to the mean value of the IP value of the material contained in the hole transport layer and the IP value of the material contained in the luminescent layer.

The Ea value of a material contained in an electron injecting promoting layer that can be provide between a luminescent layer and an electron transport layer is preferably not less than the Ea value of a material contained in the electron transport layer, and not more than the Ea value of a material contained in the luminescent layer, and more preferably close to the mean value of the Ea value of the material contained in the electron transport layer and the Ea value of the material contained in the luminescent layer.

Examples of the material of the base material of the luminescent device of the invention include, but are not limited to, inorganic materials such as yttrium stabilized with zirconium, and glass; polymeric materials including polyesters such as polyethylene terephthalate, polybutylene terephthalate and polyethylene naphthalate, polyethylene, polycarbonate, polyethersulfone, polyarylate, allyldiglycolcarbonate, polyimide, polycycloolefin, norbornene resins, poly(chloro-trifluoroethylene), TEFLON (polytetrafluoroethylene), and polytetrafluoroethylene-polyethylene copolymers.

The positive electrode supplies holes to the hole injecting layer, the hole transport layer, and/or the luminescent layer. The positive electrode can be made from a metal, an alloy, a metal oxide, an electrically conductive compound, or a mixture thereof, and is preferably made of a material having a work function of 4 eV or more. Specific examples of the material of the positive electrode include electrically conductive metal oxides such as tin oxide, zinc oxide, indium oxide, and indium tin oxide (ITO); metals such as gold, silver, chromium, and nickel; mixtures and laminated products of these metals and the electrically conductive metal oxides; electrically conductive inorganic substances such as copper iodide, and copper sulfide; electrically conductive organic substances such as polyaniline, polythiophene, and polypyrrole; and laminated products of the electrically conductive organic substances and ITO. The material of the positive electrode is preferably an electrically conductive metal oxide. The material is more preferably ITO from the viewpoints of productivity, high electrical conductivity and transparency. The thickness of the positive electrode can be suitably determined according to the material of the positive electrode, but is preferably 10 nm to 5 μm, more preferably 50 nm to 1 μm, and still more preferably 100 to 500 nm.

The positive electrode is usually an article having a layer of at least one of the above-described materials on a substrate made of soda lime glass, no-alkali glass, or a transparent resin. When the substrate is made of glass, the glass is preferably no-alkali glass in order to reduce ions deriving from the glass. When the substrate is made of soda lime glass, the substrate is preferably coated with a barrier coating such as silica. The thickness of the substrate is not limited, as long as the substrate has sufficient mechanical strength. However, when the substrate is made of glass, the thickness thereof is generally 0.2 mm or more, and preferably 0.7 mm or more.

A method for producing a positive electrode is selected according to the material of the positive electrode. When the positive electrode is an ITO film, the ITO film is formed by an electron beam method, a sputtering method, a resistance heating deposition method, a chemical reaction method (e.g., a sol-gel method), or a method of applying a dispersion of indium tin oxide.

The positive electrode can be subjected to washing or other treatment to lower the driving voltage of the device and/or to enhance luminescence efficiency. When the positive electrode is made of ITO, for example, UV-ozone treatment or plasma treatment are effective.

The negative electrode supplies electrons to the electron injecting layer, the electron transport layer, and/or the luminescent layer, and the material of the negative electrode is selected in consideration of adhesion between the negative electrode and a layer adjacent to the negative electrode, such as the electron injecting layer, the electron transport layer, and/or the luminescent layer, and ionization potential and stability of the material. The negative electrode can be made from a metal, an alloy, a metal halide, a metal oxide, an electrically conductive compound, or a mixture thereof. Specific examples of the material of the negative electrode include alkali metals such as lithium, sodium, potassium, and fluorides and oxides thereof; alkaline earth metals such as magnesium, calcium, and fluorides and oxides thereof; gold, silver, lead, aluminum, a sodium-potassium alloy, and mixed metals of these materials; a lithium-aluminum alloy and mixed metals including the lithium-aluminum alloy; a magnesium-silver alloy and mixed metals including the magnesium-silver alloy; and rare earth metals such as indium and ytterbium. The negative electrode is preferably made of a material selected from the above materials and has a work function of 4 eV or less. The material of the negative electrode is more preferably aluminum, a lithium-aluminum alloy or a mixed metal including the lithium-aluminum alloy, or a magnesium-silver alloy or a mixed metal including the magnesium-silver alloy. The negative electrode can be one layer of any of the above-described materials or multilayers including one or more of the above-described materials. For example, the negative electrode preferably has a layered structure of aluminum/lithium fluoride, or aluminum/lithium oxide. The thickness of the negative electrode can be suitably determined according to the material of the negative electrode. However, the thickness is preferably 10 nm to 5 μm, more preferably 50 nm to 1 μm, and still more preferably 100 nm to 1 μm.

The negative electrode is formed by an electron beam method, a sputtering method, a resistance heating deposition method, or a coating method. One metal can be vapor-deposited, or at least two metals can be vapor-deposited simultaneously. In order to form an alloy electrode, at least two metals can be vapor-deposited simultaneously, or an alloy prepared in advance can be vapor-deposited.

The sheet resistance of each of the positive and negative electrodes is preferably low, and, specifically, is preferably several hundred ohm/sq or less.

The materials of the luminescent layer are not particularly limited, as long as they can form a layer having a function of receiving holes from the positive electrode, the hole injecting layer or the hole transport layer and receiving electrons from the negative electrode, the electron injecting layer, or the electron transport layer when voltage is applied to the device, a function of transferring the received electrons, or a function of providing a field where holes are recombined with electrons to emit light. Examples of the materials of the luminescent layer include benzoxazole, benzimidazole, benzothiazole, styrylbenzene, polyphenyl, diphenylbutadiene, tetraphenylbutadiene, naphthalimide, coumarin, perylene, perynone, oxadiazole, aldazine, pyralidine, cyclopentadiene, bisstyrylanthracene, quinacridone, pyrrolopyridine, thiadiazolopyridine, cyclopentadiene, styrylamine, aromatic dimethylidyne compounds, metal complexes including metal complexes and rare earth metal complexes of 8-quinolinol, polymeric compounds including polythiophene, polyphenylene, polyphenylene vinylene, organic silane, iridium trisphenylpyridine complex, and transition metal complexes including platinum porphyrin complexes, and derivatives thereof. It is preferable that at least one of the materials of the luminescent layer is a phosphorescent material. The thickness of the luminescent layer of the luminescent device of the invention is not specifically limited, but is generally in a range of 1 nm to 5 μm, more preferably in a range of 5 nm to 1 μm, and still more preferably in a range of 10 nm to 500 nm.

A method for forming a luminescent layer is not particularly limited, and the examples of the method include resistance heating deposition, an electron beam method, spattering, a molecule-laminating method, a coating method (a spin coating method, a cast coating method, a dip coating method and the like), an ink-jet method, a printing method, an LB method and a transferring method. The method is preferably resistance heating deposition or a coating method.

The luminescent layer may be formed with a single compound, or with a plurality of compounds. The number of luminescent layers may be one or plural. When the number of luminescent layer is plural, these layers each may emit different luminescent colors, such as white light. A single luminescent layer may emit white light. When the number of luminescent layers is plural, these luminescent layers each may be formed with a single material, or with a plurality of compounds.

The luminescent layers of an organic electroluminescent device of the invention may have at least one laminated construction. The number of laminated layers is preferably 2 to 50, more preferably 4 to 30, and still more preferably 6 to 20.

The thickness of each layer included in a laminated layer is not particularly limited, but preferably 0.2 nm to 20 nm, more preferably 0.4 nm to 15 nm, still more preferably 0.5 nm to 10 nm, and most preferably 1 nm to 5 nm.

A luminescent layer of an organic electroluminescent device of the invention may have a plurality of domain constructions. In the luminescent layer, another domain construction may be contained. The diameter of each domain is preferably 0.2 nm to 10 nm, more preferably 0.3 nm to 5 nm, still more preferably 0.5 nm to 3 nm, and most preferably 0.7 to 2 nm.

The materials of the hole injecting layer and hole transport layer may have one of a function for receiving holes from a positive electrode, a function for transporting holes and a function for blocking electrons injected from a negative electrode. Specific examples thereof include carbazole, triazole, oxazole, oxadiazole, imidazole, polyarylalkane, pyrazoline, pyrazolone, phenylenediamine, arylamine, amino-substituted chalcone, styrylanthracene, fluorenone, hydrazone, stilbene, silazane, an aromatic tertiary amine compound, a styrylamine compound, an aromatic dimethylidyne compound and a porphyrin compound; a polysilane compound, poly(N-vinylcarbazole), an aniline copolymer, electroconductive polymers or oligomers such as thiophene oligomer and polythiophene; organic silane derivatives; carbon films; the compounds of the invention; and derivatives thereof. The thickness of each of the hole injecting layer and the hole transport layer is not specifically limited, but is preferably in a range of 1 nm to 5 μm, more preferably 5 nm to 1 μm, and still more preferably 10 nm to 500 nm. Each of the hole injecting layer and the hole transport layer may have a monolayered structure including one or more of the above-mentioned materials, or a multilayered structure including multiple layers having the same composition or different compositions.

The hole injecting layer and the hole transport layer are formed by a vacuum deposition method, an LB method, a method in which a hole injecting or transport material is dissolved or dispersed in a solvent and the resultant coating solution is applied to a substrate or any other layer (e.g., a spin coating method, a cast coating method, and a dip coating method), an ink-jet method, a printing method, or a transferring method. In the case of a coating method, the above-described material and a resin component may be dissolved or dispersed in a solvent. Examples of the resin component include polyvinyl chloride, polycarbonate, polystylene, polymetyl methacrylate, polybutyl methacrylate, polyester, polysulfone, polyphenylene oxide, polybutadiene, poly(N-vinylcarbazole), hydrocarbon resins, ketone resins, phenoxy resins, polyamide, ethylcellulose, vinyl acetate resins, ABS resins, polyurethane resins, melamine resins, unsaturated polyester resins, alkyd resins, epoxy resins, and silicone resins.

The materials of the electron injecting layer and the electron transport layer may have one of a function of receiving electrons from a negative electrode, a function of transporting electrons, and a function of blocking holes injected from a positive electrode. Specific examples thereof include triazole, oxazole, oxadiazole, imidazole, fluorenone, anthraquinodimetane, anthrone, diphenylquinone, thiopyran dioxide, carbodiimide, fluorenylidene methane, distyrylpyrazine, aromatic tetracarboxylic acid anhydride such as naphthalene tetracarboxylic acid anhydride and perylene tetracarboxylic acid anhydride, phthalocyanine, metal complexes including metal complexes of 8-quinolinol, metal phthalocyanine and metal complexes with benzoxazole and/or benzothiazole ligands, organic silanes, the compounds of the invention; and derivatives thereof. The thickness of each of the electron injecting layer and the electron transport layer is not specifically limited, but is preferably in a range of 1 nm to 5 μm, more preferably 5 nm to 1 μm, and still more preferably 10 nm to 500 nm. Each of the electron injecting layer and the electron transport layer may have a monolayered structure including one or more of the above-mentioned materials, or a multilayered structure with multiple layers having the same composition or different compositions.

The electron injecting layer and the electron transport layer are formed by a vacuum deposition method, an LB method, a method in which an electron injecting or transport material is dissolved or dispersed in a solvent and the resultant coating solution is applied to a substrate or any other layer (e.g., a spin coating method, a cast coating method, and a dip coating method), an ink-jet method, a printing method, or a transferring method. In the case of a coating method, the above-described material and a resin component may be dissolved or dispersed in a solvent. Examples of the resin component include those exemplified above as the resin component which is dissolved or dispersed in a solvent together with the hole injecting or transport material.

The material of the protective layer may have a function of preventing substances that accelerate deterioration of the device, such as moisture and oxygen, from entering the device. Specific examples thereof include metals such as In, Sn, Pb, Au, Cu, Ag, Al, Ti, and Ni; metal oxides such as MgO, SiO, SiO₂, Al₂O₃, GeO, NiO, CaO, BaO, Fe₂O₃, Y₂O₃, and TiO₂; metal fluorides such as MgF₂, LiF, AlF₃, and CaF₂; nitrides such as SiNₓ, and SiOₓN_{y}; polyethylene, polypropylene, polymethyl methacrylate, polyimide, polyurea, polytetrafluoroethylene, polychloro-trifluoroethylene, polydichloro-difluoroethylene, a chloro-trifluoroethylene/dichloro-difluoroethylene copolymer, a copolymer obtained by copolymerizing a monomer mixture including tetrafluoroethylene and at least one comonomer, fluorinated copolymers having a ring structure in the main chain of the copolymer, water-absorbing substances having a coefficient of water absorption of at least 1%, and moisture-preventive substances having a coefficient of water absorption of at most 0.1%.

A method for forming a protective layer is not particularly limited. Examples thereof include a vacuum deposition method, a sputtering method, a reactive sputtering method, a molecular beam epitaxy (MBE) method, a cluster ion beam method, an ion-plating method, a plasma polymerization method (radio frequency excitation ion-plating method), a plasma CVD method, a laser CVD method, a thermal CVD method, a gas source CVD method, a coating method, a printing method, and a transferring method.

Light-extraction efficiency of the luminescent device of the invention can be improved by various known techniques. For example, light-extraction efficiency and external quantum efficiency can be improved by modifying a substrate surface profile (by, for example, formation of a finely irregular pattern), controlling the refractive indices of a substrate, an ITO layer and an organic layer, or controlling the thicknesses of the substrate, the ITO layer and the organic layer.

The luminescent device of the invention may have a so-called top-emission structure, in which luminescence is output from a negative electrode.

### EXAMPLES

The present invention will be hereinafter set forth in more detail in terms of Examples; however, each of the Examples does not limit the invention.

### Example 1

A washed ITO substrate was placed in a vapor deposition apparatus, and copper phthalocyanine was vapor-deposited to a thickness of 10 nm thereon as a hole injecting material. Then α-NPD (N,N′-diphenyl-N,N′-di(α-naphthyl)-benzidine) was vapor-deposited to a thickness of 40 nm thereon as a hole transport material. Thereon CBP (hole injecting and transporting compound) was vapor-deposited to a thickness of 15 nm, further thereon Compound (1-1) and Compound a were co-vapor-deposited in the ratio 20:1 (mass ratio) to a thickness of 25 nm, and yet further thereon Azole Compound b (electron injecting and transporting compound) was vapor-deposited to a thickness of 40 nm. A patterned mask with a square opening to give a luminescent area of 4 mm×5 mm was placed on the organic thin film. Thereon lithium fluoride was vapor-deposited to a thickness of about 1 nm in the vapor deposition apparatus, and further thereon aluminum was vapor deposited to a thickness of about 200 nm to fabricate a device. A direct current constant voltage was applied to the EL device to emit light by means of a source measure unit Model 2400 available from Toyo Technica. The luminance was determined by a luminance meter BM-8 available from Topcon and the luminescence wavelength was determined by a spectral analyzer PMA-1 available from Hamamatsu Photonics.

As a result, a blue-luminescence having the chromaticity values of (0.17, 0.26) is obtained and the external quantum efficiency of the device is 8.5%.

The device durability is evaluated and the luminescence half time is about 200 hours, under conditions of an initial luminescence of 2000 cd/m² and a constant current value.

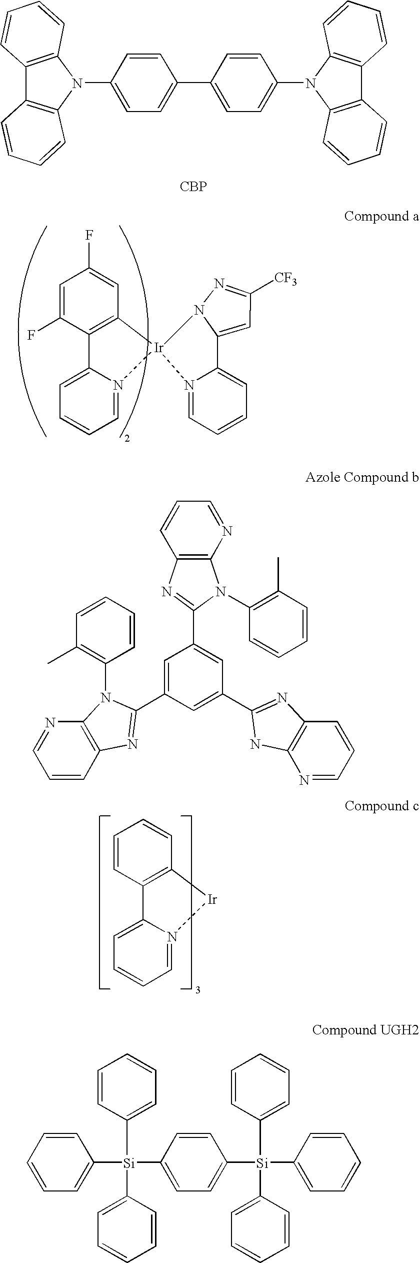

### Example 2

A device was fabricated and evaluated as in Example 1 using Compound c in place of using Compound a. As a result, a green-luminescence having the chromaticity values of (0.27, 0.62) is obtained and the external quantum efficiency of the device is 7.1%.

The device durability is evaluated, and the luminescence half time is about 630 hours, under conditions of an initial luminescence of 2000 cd/m² and a constant current value.

### Example 3

A device was fabricated and evaluated as in Example 1 using Compound c in place of Compound a and using a mixture of Compound (1-2) and CBP in the mass ratio 1:1 in place of Compound (1-1). As a result, a green-luminescence having the chromaticity values of (0.27, 0.62) is obtained, and the external quantum efficiency of the device is 7.1%.

The device durability is evaluated, and the luminescence half time is about 700 hours, under conditions of an initial luminescence of 2000 cd/m² and a constant current value.

### Comparative Example 1

A device was fabricated and evaluated as in Example 1 using the compound UGH2 described in Applied Physics Letters, 83, 3818 (2003) in place of Compound (1-1). As a result, a blue-luminescence having the chromaticity values of (0.16, 0.24) is obtained, and the external quantum efficiency of the device is 6.2%.

The device durability is evaluated, and the luminescence half time is about 120 hours, under conditions of an initial luminescence of 2000 cd/m² and a constant current value.

### Example 4

A device fabricated as in Example 1 was kept at 80° C. for 24 hours, and then the device durability was evaluated. As a result, a luminescence having the chromaticity values of (0.17, 0.26) is obtained and the external quantum efficiency of the device is 7.5%. The luminescence half time is about 180 hours, under conditions of an initial luminescence of 2000 cd/mm² and a constant current value. A device fabricated as in Comparative Example 1 was similarly kept at 80° C. for 24 hours, and then the device durability evaluation is attempted, but a short circuit of the device occurs, resulting in no luminescence.

Similarly, by using other compounds of the invention, high efficiency luminescent devices can be fabricated.

According to the invention, there can be provided an organic electroluminescent device excellent in luminescence properties, driving durability of the device and storage stability.

1. An organic electroluminescent device comprising:
a pair of electrodes, and
at least one organic layer including a luminescent layer between the pair of electrodes,
wherein the organic electroluminescent device comprises a compound represented by Formula (1): 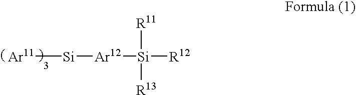
wherein Ar¹¹ may be the same as or different from each other, and represent an aryl group or a heteroaryl group; Ar¹² represents an orthophenylene group, a methaphenylene group, a biphenylene group, a group in which 3 to 6 benzene rings are linked, an arylene group of a condensed ring in which 2 to 6 aromatic rings are condensed, or a heteroarylene group; Ar¹² may be a group in which an arylene group and a heteroarylene group are linked to each other; and R¹¹, R¹², and R¹³ may be the same as or different from each other, and represent an alkyl group, an aryl group, or a heteroaryl group, and
wherein compounds represented by Formula (1) exclude diphenyl di(o-tolyl)silane and (p-bis(triphenylsilyly)benzene.

2. The organic electroluminescent device of claim 1, wherein
the luminescent layer comprises a luminescent material and the compound represented by Formula (1).

3. The organic electroluminescent device of claim 2, wherein
the luminescent material is a phosphorescent material.

4. The organic electroluminescent device of claim 2, wherein
the luminescent layer further comprises a hole injecting and transporting compound.

5. The organic electroluminescent device of claim 2, wherein
the luminescent layer further comprises an electron injecting and transporting compound.

6. The organic electroluminescent device of claim 5, wherein
the electron injecting and transporting compound is a metal complex or a heterocyclic compound comprising at least two nitrogen atoms.

7. An organic electroluminescent device comprising:
a pair of electrodes, and
at least one organic layer including a luminescent layer between the pair of electrodes,
wherein the organic electroluminescent device comprises a compound represented by Formula (2): 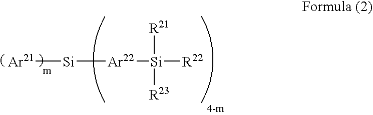
wherein Ar²¹ represents an aryl group or a heteroaryl group, and does not have a silyl group as a substituent therein; m represents 1 or 2, and when m represents 2, Ar²′ may be the same as or different from each other; Ar²² may be the same as or different from each other, and represents an arylene group or a heteroarylene group; Ar²² may be a group in which an arylene group and a heteroarylene group are linked to each other; R²¹, R²², and R²³ may be the same as or different from each other, and represent an alkyl group, an aryl group, or a heteroaryl group.

8. The organic electroluminescent device of claim 7, wherein
the luminescent layer comprises a luminescent material and the compound represented by Formula (2).

9. The organic electroluminescent device of claim 8, wherein
the luminescent material is a phosphorescent material.

10. The organic electroluminescent device of claim 8, wherein
the luminescent layer further comprises a hole injecting and transporting compound.

11. The organic electroluminescent device of claim 8, wherein
the luminescent layer further comprises an electron injecting and transporting compound.

12. The organic electroluminescent device of claim 11, wherein
the electron injecting and transporting compound is a metal complex or a heterocyclic compound comprising at least two nitrogen atoms.

13. An organic electroluminescent device comprising:
a pair of electrodes, and
at least one organic layer including a luminescent layer between the pair of electrodes,
wherein the organic electroluminescent device comprises a compound represented by Formula (3): 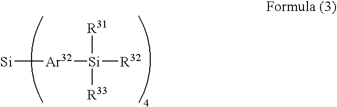
wherein Ar³² may be the same as or different from each other, and represents an arylene group, a group including an azole structure, a group including an azine structure having two or more heteroatoms, a group including a furan structure, or a group including a thiophene structure; Ar³² may be a group in which two or more of an arylene group, a group including an azole structure, a group including an azine structure having two or more heteroatoms, a group including a furan structure, or a group including a thiophene structure are linked to each other; and R³¹, R³², and R³³ may be the same as or different from each other, and represent an alkyl group, an aryl group, or a heteroaryl group.

14. The organic electroluminescent device of claim 13, wherein
the luminescent layer comprises a luminescent material and the compound represented by Formula (3).

15. The organic electroluminescent device of claim 14, wherein
the luminescent material is a phosphorescent material.

16. The organic electroluminescent device of claim 14, wherein
the luminescent layer further comprises a hole injecting and transporting compound.

17. The organic electroluminescent device of claim 14, wherein
the luminescent layer further comprises an electron injecting and transporting compound.

18. The organic electroluminescent device of claim 17, wherein
the electron injecting and transporting compound is a metal complex or a heterocyclic compound comprising at least two nitrogen atoms.
